(19) United States
(12) Patent Application Publication
(10) Pub. No.: US 2024/0210294 A1
(43) Pub. Date: Jun. 27, 2024

(54) METHOD TO EVALUATE WEAR DEPTH OF NON-METALLIC PARTS

(71) Applicant: Southwest Research Institute, San Antonio, TX (US)

(72) Inventors: Lake SPEED, JR., Concord, NC (US); Peter Mark LEE, Fair Oaks Ranch, TX (US)

(21) Appl. No.: 18/398,027

(22) Filed: Dec. 27, 2023

Related U.S. Application Data
(60) Provisional application No. 63/477,247, filed on Dec. 27, 2022.

(51) Int. Cl. G01N 3/56; G01N 15/075

(52) U.S. Cl. CPC G01N 3/56; G01N 15/075

(57) ABSTRACT

The present invention is directed at a method to evaluate the wear depth of non-metallic parts. In particular, non-metallic parts formed of polymeric material with selected amounts of metallic particles through the part thickness. Upon wear of the polymeric material the metallic particles are released which can be detected by inductively coupled plasma atomic emission spectroscopy.

### FIELD

The present invention is directed at a method to evaluate the wear depth of non-metallic parts. In particular, non-metallic parts formed of polymeric material with selected amounts of metallic particles through the part thickness. Upon wear of the polymeric material the metallic particles are released which can be detected by inductively coupled plasma atomic emission spectroscopy.

### BACKGROUND

Operating machinery typically have relatively critical parts which, when worn, will lead to downtime and expense. Regular maintenance is therefore essential to maintain operations, but maintenance expense in itself can be relatively costly and still lead to downtime, although less than what is experienced for a full failure situation.

In some situations, it is not typically practical to undertake invasive maintenance on a regular basis and therefore in lubricated systems, analysis is often made of the oils and greases associated with metal machinery or engine operations. For example, regular monitoring of metals in oils can diagnose engine wear so that preventive maintenance procedures can be performed, increasing equipment reliability.

Inductively coupled plasma atomic emission spectroscopy (ICP-AES) has been reported as an efficient technique to detect the parts per million (ppm) of metals in oil samples and the metal content can be mapped to the different components made of the metals in the machinery.

### SUMMARY

A method of evaluating wear depth of a non-metallic part comprising forming a non-metallic part with a plurality of layers wherein selected amounts of metal particles are present in said layers, exposing said non-metallic part to wear in a lubricating environment containing lubricant, and determining the metal particle concentration in said lubricant and identifying a wear depth in said non-metallic part.

A method of evaluating wear depth of a non-metallic part comprising forming a non-metallic part including one or a plurality of upper layers and one or a plurality of lower layers, embedding in said one or plurality of upper layers a first metal composition (M₁), embedding in said one or plurality of lower layers a second metal composition (M₂) that is different from M₁, exposing said non-metallic part to wear in a lubricating environment containing lubricant, and identifying the presence of metal particles M₁ and M₂ in said lubricant and a wear depth of said non-metallic part.

### DETAILED DESCRIPTION OF PREFERRED EMBODIMENTS

ICP-AES analysis is reference here to a technique for determining metal constituents of metal particulate that is suspended in a liquid (e.g. a lubricating oil). The technique is based upon generation of an inductively coupled plasma utilizing RF energy. The liquid samples may be converted into an aerosol and injected into a plasma. As the sample enters the plasma, it volatilizes, atomizes, excites and ultimately emits photon characteristic of the wavelengths of the metals present in the sample. The intensity of the emission at characteristic wavelengths is used to determine the concentration of a metal element present in the sample. The plasma is typically supported by argon gas but other gases may be employed.

It is contemplated herein that non-metallic parts, whose wear characteristics would be considered important to monitor, may now be made of polymeric material with selected amounts of embedded metallic particles. The metallic particles may preferably have a particle size in the range of 1.0 μm to 999.0 μm, including all individual values and ranges therein. The metallic particles that are therefore to be embedded within the polymeric material are preferably selected from a metallic material that is different than other metals that are present in the system. For example, in an engine where there is already steel, copper, and/or lead, one would preferably select aluminum in particulate form for selectively loading in the polymer whose wear characteristics within the engine are to be evaluated.

Preferably, the polymeric material of the part whose wear characteristics is to be evaluated is now formed such that the density of the metal particle impregnation is selectively varied and increased from the surface down to a selected lower layer(s). It is contemplated that the number of layers in the polymeric material with increasing density of metallic particles in each respective layer may preferably fall in the range of 2-15 layers. It is also contemplated that the formation of such a multi-layered polymeric material component with increasing density of metallic particles in each respective layer may be conveniently achieved by additive manufacturing or extrusion

For example, the density of metallic particles in the polymer material at the surface down to a thickness of 1.0 mm may be zero, at a thickness of greater than 1.0 mm to 2.0 mm the density of the metallic particles is equal to D₁, at a thickness of greater than 2.0 mm to 3.0 mm the density of the metallic particles is equal to D₂, and at a thickness of greater than 3.0 mm to 4.0 mm the density of the metallic particles is equal to D₃, and at a thickness of greater than 4.0 mm to 5.0 mm the density of the metallic particles is equal to D₄. In this situation, D₂>D₁, D₃>D₂ and D₄>D₃.

When such polymeric material is subject to wear in lubricated engine environment, the lubricant (oil) can then be conveniently collected and analyzed by inductively coupled plasma atomic emission spectroscopy (ICP-AES). More specifically, one may utilize ASTM D5185 (2018), Determination of Additive Elements, Wear, Metals and Contaminants in Used Lubricating Oils and Determination of Selected Elements in Based Oils by ICP-AES. It is therefore contemplated that one may monitor and detect the presence of the metal particle density level and then map that to the density levels D₁, D₂, D₃, and D₄ noted above. In such manner, the user is now made aware of the relative wear depth of the polymeric material at issue as well as the wear of metallic components of the engine under consideration.

By way of one more specific example, in the case of chain tensioner made of polymeric material, used to maintain the tension within the roller timing chain systems of a combustion engine, it is contemplated that such chain guide could be made of eight layers of polymeric material. In such a chain tensioner, it is preferably that the tensioner should be replaced when the wear depth has reached 50% of the original depth. Accordingly, the density of the metallic particles in the first three (3) layers may be set relatively lower than the density in layers 4, 5, 6, 7 and 8. Upon use of such chain tensioner made of polymeric material, in a lubricated environment, the lubricant (oil) can be collected and analyzed according to ASTM D5185 (2018). Upon identification of the metal particle density levels associated with layers 4, 5, 6, 7 or 8, one may readily determine that the tensioner is to be replaced.

Moreover, it is contemplated herein that the polymeric material of the part whose wear characteristics is to be evaluated may also be formed such that the composition of the metal particle impregnation is selectively varied from the surface down to one or a plurality of selected lower layer(s). For example, the metal particles impregnated in one or more of the upper layers down from the surface may comprise a first metal composition (M₁) and the metal particles impregnated in one or more of the lower layers may comprise a second metal composition (M₂), where the compositions of M₁ and M₂ are different. For example, composition M₁ may preferably be steel and composition M₂ may preferably be aluminum. Accordingly, in a lubricated environment, the release of the first metal composition (M₁) due to wear followed by analysis by inductively coupled plasma atomic emission spectroscopy (ICP-AES) is contemplated to indicate to the user that there is an acceptable amount of wear. However, upon further wear and release of the second metal composition (M₂), ICP-AES analysis can then indicate an unacceptable level of wear or that some critical wear point has been reached to signify that the non-metallic part at issue must be promptly replaced.

In addition, it can be appreciated from the above that one may utilize, for example, a gradient of different metal compositions (e.g. M₁, M₂, M₃ . . . . Mₓ) in the particles that are selectively and individually embedded in the plurality of layers of the non-metallic part down from the surface. For example, particles with metal composition M₁ embedded in one or more of the initial layer(s) down from the surface, particles with metal composition M₂ embedded in one or more of the intermediate layer(s) down from the surface, and particles with metal composition M₃ embedded in one or more of the lower layer(s) down from the surface. In such a manner, and upon wear of the non-metallic part in a lubricating environment and release of a particular metal particle composition M₁, M₂ or M₃, it is contemplated that one may assign a specific gradient type level of wear to the part whose wear analysis is under evaluation.

The polymeric materials herein that are contemplated for use include thermoplastics and thermosets. As alluded to above, additive manufacturing may be employed to produce polymeric parts with a plurality of layers have varying density distribution of the metallic particles within the individual layers. The polymer may more preferably be selected from acrylonitrile-butadiene styrene (ABS), polyethylene terephthalate (PET), polycarbonate, polyetheretherketones (PEK), polypropylene, polyamides, fluorocarbon polymers (e.g., polytetrafluroethylene or PTFE), epoxy resins and/or polyurethanes.

As may now be appreciated, the present invention relates to method of evaluating wear depth of a non-metallic part comprising forming a non-metallic part with a plurality of layers wherein selected amounts of metal particles of the same or different composition are present in the layers. This is then followed by exposing the non-metallic part to wear in a lubricating environment containing lubricant. One may then determine the metal particle concentration and/or metal composition in the lubricant and identify a wear depth in the non-metallic part.

What is claimed is:

1. A method of evaluating wear depth of a non-metallic part comprising:
a. forming a non-metallic part with a plurality of layers wherein selected amounts of metal particles are present in said layers;
b. exposing said non-metallic part to wear in a lubricating environment containing lubricant;
c. determining the metal particle concentration in said lubricant and identifying a wear depth in said non-metallic part.

2. The method of claim 1 wherein metal particle concentration in said lubricant is determined by inductively coupled plasma atomic emission spectroscopy.

3. The method of claim 1 wherein said non-metallic part comprises polymeric material.

4. The method of claim 3 wherein said polymeric material is acrylonitrile-butadiene styrene (ABS), polyethylene terephthalate (PET), polycarbonate, polyetheretherketones (PEK), polypropylene, polyamides, fluorocarbon polymers (e.g., polytetrafluroethylene or PTFE), epoxy resins or polyurethanes.

5. The method of claim 1 wherein said non-metallic part has selected amounts of metal particles present in said layers at selected density levels for each of said layers.

6. The method of claim 5 wherein said non-metallic part has a surface and the density level of said metal particles present in said layers increases from said surface of the non-metallic part down to a selected lower layer.

7. The method of claim 1 wherein said non-metallic part with said plurality of layers comprises a first layer with no metallic particles.

8. The method of claim 1 wherein said non-metallic part with said plurality of layers comprises a first layer at a thickness of up to 1.0 mm having no metallic particles, a second layer at a thickness of greater than 1.0 mm to 2.0 mm where the density of the metallic particles is D₁, a third layer at a thickness of greater than 2.0 mm to 3.0 mm where the density of the metallic particles is D₂, a fourth layer at a thickness of greater than 3.0 mm to 4.0 mm where the density of the metallic particles is D₃, and a fifth layer at a thickness of greater than 4.0 mm to 5.0 mm where the density of the metallic particles is D₄, wherein D₂>D₁, D₃>D₂ and D₄>D₃.

9. The method of claim 1 wherein said plurality of layers comprises 2-15 layers.

10. The method of claim 1 wherein said metal particles have a particle size of 1.0 μm to 999.0 μm.

11. The method of claim 1 wherein said lubricating environment comprises a lubricated engine environment.

12. The method of claim 1 wherein said metal particles are steel, copper, lead or aluminum.

13. A method of evaluating wear depth of a non-metallic part comprising:
a. forming a non-metallic part including one or a plurality of upper layers and one or a plurality of lower layers;
b. embedding in said one or plurality of upper layers a first metal composition (M₁);
c. embedding in said one or plurality of lower layers a second metal composition (M₂) that is different from M₁;
d. exposing said non-metallic part to wear in a lubricating environment containing lubricant;
e. identifying the presence of metal particles M₁ and M₂ in said lubricant and a wear depth of said non-metallic part.

14. The method of claim 13 wherein metal particles M₁ and M₂ in said lubricant are identified by inductively coupled plasma atomic emission spectroscopy.

15. The method of claim 13 wherein said non-metallic part comprises polymeric material.

16. The method of claim 15 wherein said polymeric material is acrylonitrile-butadiene styrene (ABS), polyethylene terephthalate (PET), polycarbonate, polyetheretherketones (PEK), polypropylene, polyamides, fluorocarbon polymers (e.g., polytetrafluroethylene or PTFE), epoxy resins or polyurethanes

17. The method of claim 13 wherein said metal particles have a particle size of 1.0 μm to 999.0 μm.

18. The method of claim 13 wherein said metal particles are steel, copper, lead or aluminum.

19. The method of claim 13 wherein said lubricating environment comprises a lubricated engine environment.
